(19) United States
(12) Patent Application Publication
(10) Pub. No.: US 2010/0229188 A1
(43) Pub. Date: Sep. 9, 2010

(54) Presenting Data Files to an Application Based on a Characteristic of the Application and the Files

(75) Inventors: Kavitha Vittal Murthy Baratakke, Austin, TX (US); Shashidhar Bomma, Cotton Wood Heights, UT (US); Brian W. Hart, Austin, TX (US); Nikhil Hegde, Round Rock, TX (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/396,696

(22) Filed: Mar. 3, 2009

(51) Int. Cl. G06F 9/46

(52) U.S. Cl. 719/328

(57) ABSTRACT

In accordance with the invention, it has been recognized that for an application that is of a particular type and has certain characteristics, a benefit can be achieved by presenting multiple files to the application in a particular pre-planned or pre-specified order. Accordingly, an embodiment of the invention is directed to a method in a data processing system, wherein information pertaining to multiple data files is located in a container, and a plurality of applications of different types are each disposed to request a presentation of the files. Responsive to a request from a given application for presentation of the files, it is determined that the given application is of a particular type. The method further includes specifying an order for the presentation of the files, wherein the specified order is pre-selected to achieve an objective associated with applications of the given type. The files are then presented to the given application in the specified order.

### BACKGROUND OF THE INVENTION

1. Field of the Invention

The invention disclosed and claimed herein generally pertains to a method for presenting files to an application in an order that is based on a particular characteristic of the application. More particularly, the invention pertains to a method of the above type wherein the order of the presentation is pre-selected, to achieve an objective associated with the application characteristic, and relies on characteristics of the files.

2. Description of the Related Art

Many computer operating systems provide hiearchical storage for data files. In these systems, files are organized in containers, often known as “directories” or “folders”, which contain information pertaining to the files. Such systems provide application programming interfaces (APIs), to allow applications on the system to retrieve a list of the files from a container.

Some computer environments provide an interface that allows an application to make only a single call, in order to retrieve information about all the files that are in a container. JAVA, for example, provides a listFiles ( )method that can be applied once to retrieve information about all the files that reside in a container. In other environments, an interface is provided that requires repeated calls to retrieve the entire list of files in the container. In UNIX, for example, an application can call opendir ( ) as a prelude to a series of readdir ( ) calls, each of which will retrieve information about a single file in the directory.

In either of the above cases, the computer environment will return the list of files in an ordering that is convenient for the environment. However, such orderings are without regard for how well an ordering suits the requester of the application.

As used herein, the term “computer environment” refers to a computer system and a file system that are configured to interact together.

### BRIEF SUMMARY OF THE INVENTION

In accordance with the invention, it has been recognized that for an application that is of a particular type and has certain characteristics, a benefit can be achieved by presenting multiple files to the application in a particular pre-planned or pre-specified order. Accordingly, an embodiment of the invention is directed to a method in a data processing system, wherein information pertaining to multiple data files is located in a container, such as a folder or a directory, and a plurality of applications of different types are each disposed to request a presentation of the files. Responsive to a request from a given application for presentation of the files, it is determined that the given application is of a particular type. The method further includes specifying an order for the presentation of the files, wherein the specified order is pre-selected to achieve an objective associated with applications of the given type. The files are then presented to the given application in the specified order.

### BRIEF DESCRIPTION OF THE SEVERAL VIEWS OF THE DRAWINGS

FIG. 1 is a flowchart showing steps for a method comprising an embodiment of the invention.

FIG. 2 is a schematic diagram showing a configuration of components that cooperatively interact to implement embodiments of the invention.

FIG. 3 is a block diagram showing a data processing system which may be used to provide respective components for the configuration of FIG. 2.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

A principal purpose of embodiments of the invention is to provide a list of files in a data processing system to an application that requests the files. Moreover, the list is constructed so that it will cause respective files to be presented to the application, in an order that is specifically adapted or designed in view of the application. More particularly, it has been recognized that if the application is to be used to perform a certain task, the order in which the files are presented to the application can be selected, by judicious preparation of the list, to achieve a benefit related to the task.

As an example, an application could perform the task of deleting a succession of files from a database or other data storage. In accordance with embodiments of the invention, it has been recognized that it would be desirable to delete the files that were least important, before deleting the files that were most important. Then, if it turned out that the application had been invoked in error, there would be more opportunity to interrupt the application before the most important files were deleted.

In another example, an application could be of a type that backed up successive files from a storage container. In this situation, it would be advantageous to back up the most recently changed files first. Then, if the application was interrupted, it would be more likely that the most recently changed files were backed up before the interruption occurred. This is beneficial, because it would be more probable that the less recently changed files had already been backed up, during a previous back up session.

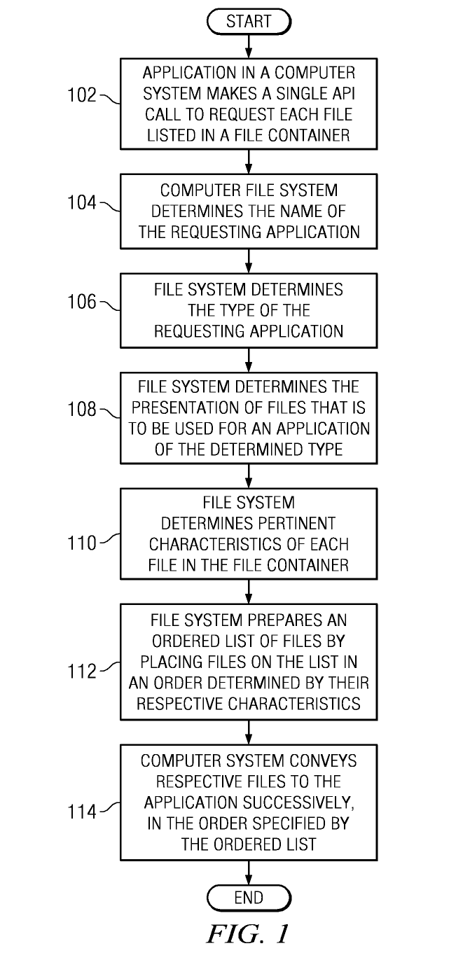

Referring to FIG. 1, there is shown a flowchart illustrating steps for a method comprising an embodiment of the invention. As shown by step 102, an application in a computer system makes a single API call, in order to request each file that is listed in a file container, as residing in a database or other repository associated with the computer system. In response to the single request, the computer system invokes a file system that is included in the computer system, or is otherwise associated therewith. The file system is then operated to determine the name of the requesting application, as shown by step 104 of FIG. 1.

After the application name has been determined, this information is used to determine the application type, as indicated at step 106. For example, if the application is associated with the command “cp” in Unix, it is of a type that will perform a copy function on each of the listed files in the file container. If the application is of a type associated with an rm command, it will successively delete each file. In a useful embodiment, the file system determines the application type by consulting a map that is contained in the computer system.

Referring further to FIG. 1, at step 108 the file system determines the presentation of files that should be used for an application of a particular type. That is, the file system determines the order in which respective files should be successively presented to the application for processing, in view of the application type. For example, as described above, if the application is of a type that will delete each file, the files should be presented in a ranked order, starting with the least important file and ending with the most important file. Generally, in a ranked order of this sort, a file immediately following a given file would be more important than the given file, and a file immediately preceding a given file would be less important than the given file.

As a further example, and as likewise described above, if the application is of a type that will copy respective files, the files should again be successively presented to the application in a ranked order. However, this ranked order should present the most important file first, and present the least important file last. Usefully, the file system may determine the appropriate order of file presentation by consulting a map contained in the computer system.

At step 110, the file system determines one or more characteristics of each file, wherein the characteristics are pertinent to the particular presentation of files that was determined at step 108. As an example of this, the application type could require files to be presented in a ranked order from the least important file to the most important file. For this situation, a characteristic must be selected for each file that can be used to readily decide whether the file is more important or less important than every other file. In one arrangement, it could be that any given file listed in the file container was more important than all files that were created before the given file. For this arrangement, step 110 could determine that the pertinent characteristic, for each file was the date and time of file creation. Other embodiments of the invention could use other characteristics.

At step 112, the file system uses the characteristics of respective files, as determined at step 110, to construct an ordered list. That is, each file is placed on the list in the order it is to be presented to the application, in view of the application type. Then, at step 114, the computer system carries out the presentation, by conveying respective files to the application in the order specified by the ordered list. This action completes the single API call of step 102.

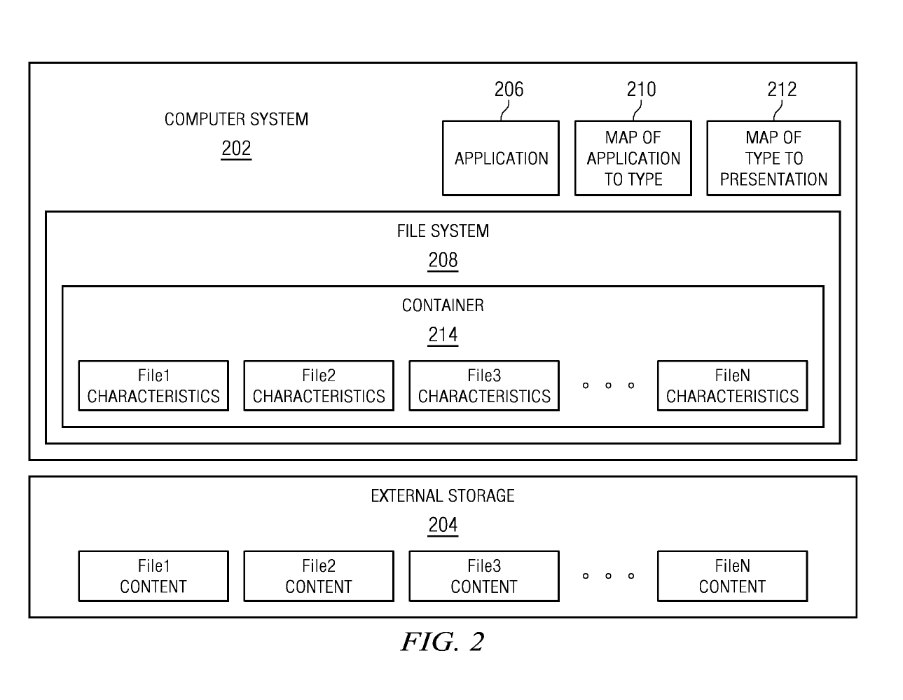

Referring to FIG. 2, there is shown a computer system 202 that is operable in co-operation with an external data storage 204, such as a database or the like, to implement embodiments of the invention. Data storage 204 contains the contents of multiple data files, such as files 1-N. Computer system 202 contains or incorporates a number of the components discussed above. These include multiple applications of different types, represented in FIG. 2 by application 206, and a file system 208. Computer system 202 also includes maps 210 and 212. For a particular application, map 210 can be used to determine the type of that application. For a particular application type, map 212 can be used to determine the order of the presentation that is to be used for that type.

Referring further to FIG. 2, there is shown a file information container 214, such as a folder or directory. A list of files 1-N is located in container 214, as well as other information for each file, such as file characteristics of the type described above.

In implementing an embodiment of the invention, the computer system could monitor a sequence of API calls sent from a particular application. The sequence of API calls could then be used in determining that the particular application was of a particular type.

A further embodiment of the invention could be enabled via an on-disk flag set by an administrator, at the time of creation of the file system, dynamically at any time, or by a mount option.

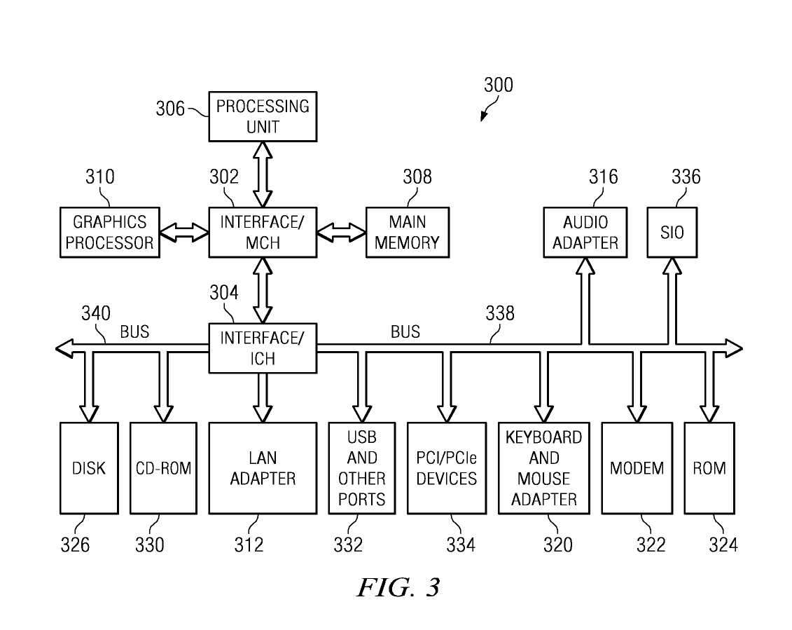

Referring to FIG. 3, a block diagram of a data processing system is shown in which aspects of the present invention may be implemented. Data processing system 300 may be used to provide computer system 202 in FIG. 2, as an example of a computer, in which computer usable code or instructions implementing the processes for embodiments of the present invention may be located.

In the depicted example, data processing system 300 employs a hub architecture including north bridge and memory controller hub (NB/MCH) 302 and south bridge and input/output (I/O) controller hub (SB/ICH) 304. Processing unit 306, main memory 308, and graphics processor 310 are connected to NB/MCH 302. Graphics processor 310 may be connected to NB/MCH 302 through an accelerated graphics port (AGP).

In the depicted example, local area network (LAN) adapter 312 connects to SB/ICH 304. Audio adapter 316, keyboard and mouse adapter 320, modem 322, read only memory (ROM) 324, hard disk drive (HDD) 326, CD-ROM drive 330, universal serial bus (USB) ports and other communication ports 332, and PCI/PCIe devices 334 connect to SB/ICH 304 through bus 338 and bus 340. HDD 226 may be used to provide external storage 204. PCI uses a card bus controller, while PCIe does not. ROM 324 may be, for example, a flash binary input/output system (BIOS).

HDD 326 and CD-ROM drive 330 connect to SB/ICH 304 through bus 340. HDD 326 and CD-ROM drive 330 may use, for example, an integrated drive electronics (IDE) or serial advanced technology attachment (SATA) interface. Super I/O (SIO) device 336 may be connected to SB/ICH 304.

An operating system runs on processing unit 306 and coordinates and provides control of various components within data processing system 300 in FIG. 3. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 300 (Java is a trademark of Sun Microsystems, Inc. in the United States, other countries, or both).

As a server, data processing system 300 may be, for example, an IBM® eServer™ System p computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 300 may be a symmetric multiprocessor (SMP) system including a plurality of processors in processing unit 306. Alternatively, a single processor system may be employed.

Instructions for the operating system, the object-oriented programming system, and applications or programs are located on storage devices, such as HDD 326, and may be loaded into main memory 308 for execution by processing unit 306. The processes for embodiments of the present invention are performed by processing unit 306 using computer usable program code, which may be located in a memory such as, for example, main memory 308, ROM 324, or in one or more peripheral devices 326 and 330.

Those of ordinary skill in the art will appreciate that the hardware in FIGS. 1-3 may vary depending on the implementation. Other internal hardware or peripheral devices, such as flash memory, equivalent non-volatile memory, or optical disk drives and the like, may be used in addition to or in place of the hardware depicted in FIGS. 1-3. Also, the processes of the present invention may be applied to a multiprocessor data processing system.

In some illustrative examples, data processing system 300 may be a personal digital assistant (PDA), which is configured with flash memory to provide non-volatile memory for storing operating system files and/or user-generated data.

A bus system may be comprised of one or more buses, such as bus 338 or bus 340 as shown in FIG. 3. Of course, the bus system may be implemented using any type of communication fabric or architecture that provides for a transfer of data between different components or devices attached to the fabric or architecture. A communication unit may include one or more devices used to transmit and receive data, such as modem 322 or network adapter 312 of FIG. 3. A memory may be, for example, main memory 308, ROM 324, or a cache such as found in NB/MCH 302 in FIG. 3. The depicted examples in FIGS. 1-3 and above-described examples are not meant to imply architectural limitations. For example, data processing system 300 also may be a tablet computer, laptop computer, or telephone device in addition to taking the form of a PDA.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In a data processing system, wherein information pertaining to multiple data files is located in a container, and a plurality of applications of different types are each disposed to request a presentation of the files, a method comprising the steps of:
responsive to a request from a given application for a presentation of the files, determining that the given application is of a particular type;
specifying an order for the presentation of said files, wherein said specified order is pre-selected to achieve an objective associated with applications of said particular type; and
presenting said files to said given application in said specified order.

2. The method of claim 1, wherein:
a map is used to determine that said given application is of said particular type.

3. The method of claim 1, wherein:
an API call is used to indicate that said given application is of said particular type.

4. The method of claim 1, wherein:
said given application is of a type that is disposed to delete the files to be presented, and said files are successively presented in a ranked order, wherein a least important file is presented first, and a most important file is presented last.

5. The method of claim 1, wherein:
said particular application is of a type that is disposed to copy the presented files, and said files are successively presented in a ranked order, wherein a most important file is presented first, and a least important file is presented last.

6. The method of claim 1, wherein:
a system associated with said container monitors a sequence of API calls send from said given application, and uses said sequence of API calls to determine that said given application is of said particular type.

7. In a data processing system, wherein information pertaining to multiple data files is located in a container, and a plurality of applications of different types are each disposed to request a presentation of the files, a computer program product executable in a computer readable medium comprising:
instructions responsive to a request from a given application for a presentation of the files, for determining that the given application is of a particular type;
instructions for specifying an order for the presentation of said files, wherein said specified order is pre-selected to achieve an objective associated with applications of said particular type; and
instructions for presenting said files to said given application in said specified order.
